(19) United States
(12) Patent Application Publication
(10) Pub. No.: US 2022/0236733 A1
(43) Pub. Date: Jul. 28, 2022

(54) VIRTUAL MAPPING SYSTEMS AND METHODS FOR USE IN AUTONOMOUS VEHICLE NAVIGATION

(71) Applicant: 6 River Systems, LLC, Waltham, MA (US)

(72) Inventors: Apoorva Gupta, Waltham, MA (US); Matthew Bittarelli, Concord, MA (US)

(21) Appl. No.: 17/157,067

(22) Filed: Jan. 25, 2021

(51) Int. Cl. G05D 1/00; G05D 1/02; G01C 21/00; G06K 9/00

(52) U.S. Cl. CPC G05D 1/0088; G05D 1/0212; G01C 21/383; G05D 2201/0206; G06K 9/00805; G05D 2201/0216; G05D 2201/0211; G05D 1/0027

(57) ABSTRACT

Disclosed herein are systems and methods for virtual mapping in autonomous vehicle operation. The systems and methods include navigating, by a computing system, a virtual model of an autonomous vehicle through a virtual environment corresponding to an interior space of a real-world building; generating, by the computing system, a virtual map of the interior space for the autonomous vehicle based on the navigation through the virtual environment; and transmitting, by a communication device of the computing system, the virtual map to the autonomous vehicle for navigating the interior space.

### TECHNICAL FIELD

The following disclosure is directed to systems and methods for virtual mapping and navigation and, more specifically, systems and methods for virtual mapping for use in autonomous vehicle operation.

### BACKGROUND

Autonomous vehicles can be configured to navigate open spaces (e.g., in air, over land, under water, etc.). For example, autonomous vehicles can be configured to navigate within an area that includes obstacles or humans. Such an area may be a warehouse, a retail store, a hospital, an office, etc. To successfully navigate such areas, autonomous vehicles can rely on one or more sensors.

### SUMMARY

Described herein are example systems and methods for virtual mapping in autonomous vehicle operation.

In one aspect, the disclosure features a computing system for virtual mapping in autonomous vehicle operation. The computing system can include a processor configured to navigate a virtual model of an autonomous vehicle through a virtual environment corresponding to an interior space of a real-world building, and generate a virtual map of the interior space for the autonomous vehicle based on the navigation through the virtual environment. The computing system can further include a communication device coupled to the processor and configured to transmit the virtual map to the autonomous vehicle for navigating the interior space.

Various embodiments of the computing system can include one or more of the following features.

The virtual map can include a set of virtual sensor markers, in which the virtual sensor markers are modeled sensor data for at least one sensor of the autonomous vehicle. The set of virtual sensor markers can include at least one of image markers or depth markers. The virtual map can be generated in at least two lighting conditions, in which the lighting conditions include a first and second lighting level. The first lighting level can be different from the second lighting level and each of the first and second lighting levels is one of a high level of lighting, a normal level of lighting, a low level of lighting, or an uneven level of lighting. The processor can be further configured to generate the virtual model of the autonomous vehicle based on a set of autonomous vehicle specifications.

The system can further include a controller configured to navigate the autonomous vehicle in the interior space according to the virtual map. The system can further include a memory coupled to the processor and configured to store data from at least one sensor of the autonomous vehicle obtained during navigation of the autonomous vehicle in the interior space, in which the processor is further configured to modify the virtual map according to the stored data. The processor can be further configured to receive a dataset including (i) a blueprint for the interior space of the physical building, and (ii) a plurality of images of the interior space, and generate the virtual environment of the interior space based on the received dataset.

In another aspect, the disclosure features a computer-implemented virtual mapping method for autonomous vehicle operation. The method can include navigating, by a computing system, a virtual model of an autonomous vehicle through a virtual environment corresponding to an interior space of a real-world building; generating, by the computing system, a virtual map of the interior space for the autonomous vehicle based on the navigation through the virtual environment; and transmitting, by a communication device of the computing system, the virtual map to the autonomous vehicle for navigating the interior space.

Various features of the computer-implemented virtual mapping method can include the virtual map including a set of virtual sensor markers, the virtual sensor markers being modeled sensor data for at least one sensor of the autonomous vehicle. The set of virtual sensor markers can include at least one of image markers or depth markers. The virtual map can be generated in at least two lighting conditions, in which the lighting conditions include a first and second lighting level. The first lighting level can be different from the second lighting level and each of the first and second lighting levels are one of a high level of lighting, a normal level of lighting, a low level of lighting, or an uneven level of lighting. The method can further include generating, by the computing system, the virtual model of the autonomous vehicle based on a set of autonomous vehicle specifications.

The method can further include navigating, by a controller of the autonomous vehicle, the autonomous vehicle in the interior space according to the virtual map. Navigating the autonomous vehicle in the interior space according to the virtual map can include autonomously navigating, by the controller, the autonomous vehicle in the interior space. The method can include storing, by a memory coupled to the computing system, data from at least one sensor of the autonomous vehicle obtained during the navigating of the autonomous vehicle in the interior space; and modifying, by the computing system, the virtual map according to the stored data. The method can include transmitting, by the computing system, the modified virtual map to another autonomous vehicle. The virtual environment can be a three-dimensional model of the interior space of the real-world building. The method can further include receiving, by the computing system, a dataset including (i) a blueprint for the interior space of the real-world building, and (ii) a plurality of images of the interior space; and generating, by the computing system, the virtual environment of the interior space based on the received dataset.

In one aspect, the disclosure features a non-transitory computer-readable medium having instructions stored thereon that, when executed by one or more computer processors, cause the computer processors to perform operations comprising: navigating a virtual model of an autonomous vehicle through a virtual environment corresponding to an interior space of a real-world building; generating a virtual map of the interior space for the autonomous vehicle based on the navigation through the virtual environment; and transmitting the virtual map to the autonomous vehicle for navigating the interior space.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the systems and methods described herein. In the following description, various embodiments are described with reference to the following drawings.

FIG. 1A is a model of an embodiment of an autonomous vehicle configured to execute tasks within a warehouse-type environment.

FIG. 1B is a model of another embodiment of an autonomous vehicle configured to execute tasks within a warehouse-type environment.

FIG. 2A is a diagram of an embodiment of computing systems for autonomous vehicle operation.

FIG. 2B is a diagram of an embodiment of computing systems for virtual mapping for autonomous vehicle operation.

FIG. 3 is a flowchart of an embodiment of a method for virtual mapping in autonomous vehicle operation.

FIG. 4 is an image of an embodiment of a three-dimensional (3D) virtual environment of an interior space of warehouse.

FIG. 5 is an image of an embodiment of a virtual model of an autonomous vehicle in a virtual environment.

FIG. 6 is an image of an embodiment of the virtual model of FIG. 5 being navigated in a virtual environment.

FIG. 7A is an image of an embodiment of a virtual model of two vehicle sensors and their respective virtual fields of view.

FIG. 7B is an image of an embodiment of the visual sensor data captured by the virtual sensors of FIG. 7A.

FIG. 8A is an image of an embodiment of the virtual model of FIG. 5 being navigated in a test virtual environment.

FIG. 8B is an image of an embodiment of the resulting sensor data from the navigation in FIG. 8A.

FIG. 9 is a block diagram of an embodiment of a computer system used in implementing the systems and methods described herein.

### DETAILED DESCRIPTION

A conventional warehouse can become “automated” by enabling a set of vehicles to navigate autonomously through its interior space. In an automated warehouse setting (or in a retail store, a grocery store, a hospital ward, etc.), a computing system (e.g., a computing system internal 206 or external 202 to an autonomous vehicle 102) can determine a path for the autonomous vehicle 102, thereby enabling the vehicle to collect or transport items located throughout the warehouse (e.g., according to a picklist for a customer order or for restocking inventory). A controller 220 of the autonomous vehicle 102 can navigate the vehicle through an optimized sequence of locations within the warehouse such that a worker (also referred to as an associate or picker) or a mechanical device (e.g., a robotic arm coupled to the autonomous vehicle) can physically place an item into a container (also referred to as a tote) for the vehicle to carry. Importantly, navigation of the autonomous vehicle 102 requires the vehicle to avoid obstacles (including humans, shelves, other vehicles, etc.). Automated warehouses can be organized to include a series of aisles, vehicle charging areas, meeting points, inventory locations, receiving areas, sortation areas, and/or packing/shipping areas.

To become an automated warehouse, it is beneficial for the conventional warehouse to undergo an initial mapping process so that autonomous vehicles can safely and efficiently navigate the interior space of the warehouse. The initial mapping of the interior space of the warehouse for vehicle navigation may require one or more prolonged periods of downtime for the warehouse. Such downtime can include reduced activity (e.g., by humans, by vehicles, etc.) within the warehouse and, consequently, reduced productivity in picking items for orders, moving inventory, and/or shipping orders to customers. Downtime can be important to enable one or more “mapping” autonomous vehicles to navigate and map the interior space of the warehouse.

The mapping process may require that the navigation path(s) of the mapping autonomous vehicle are clear of obstacles (e.g., humans, other autonomous vehicles, objects, debris, temporary structures) so that the autonomous can safely navigate and/or avoid interference with within the field of view of its sensor(s) 222. Accordingly, the mapping autonomous vehicle can use one or more sensors 222 to collect sensor data along the navigation path(s) that will be used during operation of the automated warehouse. In one sense, the mapping autonomous vehicle relies on one or more sensors 222 to collect sensor data to form a sensor “map” of the interior space to be used by one or more autonomous vehicles.

Additionally or alternatively, the initial mapping of the warehouse may require skilled labor (e.g., an engineer or trained technician) to accompany the vehicle in manually mapping the interior space. For example, a skilled engineer may need to guide the vehicle through each of the paths in the warehouse one or more times to ensure safe operation (e.g., navigating between aisles and around corners). For example, the skilled engineer may need to walk with the vehicle, need to push the vehicle, and/or use a controller (e.g., a joystick) to control the vehicle around the warehouse during initial mapping. During the initial mapping, the autonomous vehicle may utilize one or more sensors (e.g., image sensors, depth sensors, etc.) to gather sensor data indicative of navigation cues within the interior space. This sensor data, also referred to as sensor markers, can be important for the vehicle (and other autonomous vehicles) to traverse the same paths during normal autonomous operation safely and efficiently. However, there exists a risk that certain areas of the warehouse may not be properly captured by sensor(s) of the vehicle during initial mapping due to glare (strong light on interior surfaces) or unavoidable obstacles if the warehouse isn't fully shut down (e.g., humans walking around). Further, given the short time that is allocated for initial mapping of a warehouse, not all warehouse conditions may be captured. For example, the full breadth of lighting conditions (e.g., overcast days, sunny days, etc.) may not be captured during initial mapping.

While initial mapping is important to the success of automating the warehouse, it also requires time and resources by the warehouse operator and/or the autonomous vehicle system operator to execute. This investment of time and resources may decrease the adoption of the autonomous vehicle system in conventional warehouses and prevent long-term gains in productivity.

In some embodiments, the initial mapping required for converting a conventional (non-automated) warehouse to an automated warehouse (in which autonomous vehicles navigate) can be attained by generating a virtual model of the warehouse and virtually navigating virtual models of autonomous vehicles in the virtual model. In particular, the initial (i.e., virtual) maps attained thereby can include sensor markers based on vehicle specifications for safe and efficient operation within the physical warehouse.

In at least some embodiments, the technology described herein may be employed in mobile carts of the type described in, for example, U.S. Pat. No. 9,834,380, issued Dec. 5, 2017 and titled “Warehouse Automation Systems and Methods,” the entirety of which is incorporated herein by reference and described in part below.

### Example Application to Autonomous Warehouse Carts

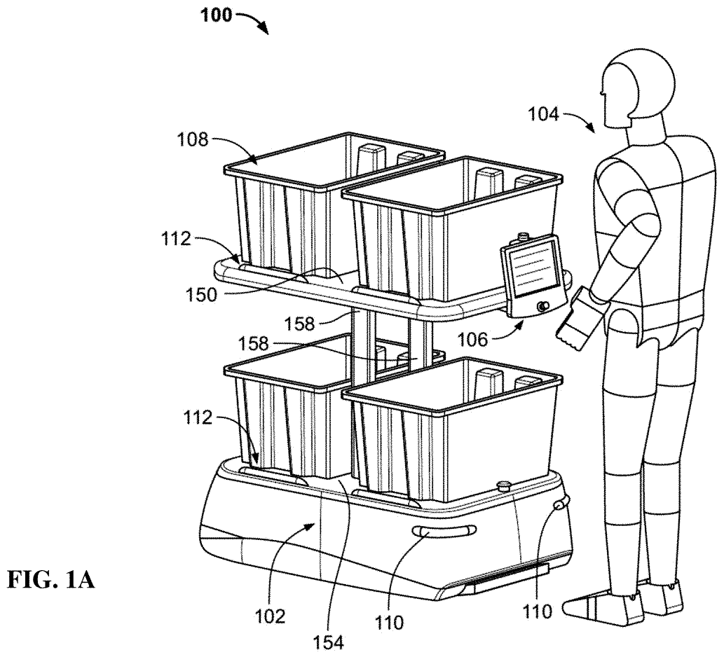

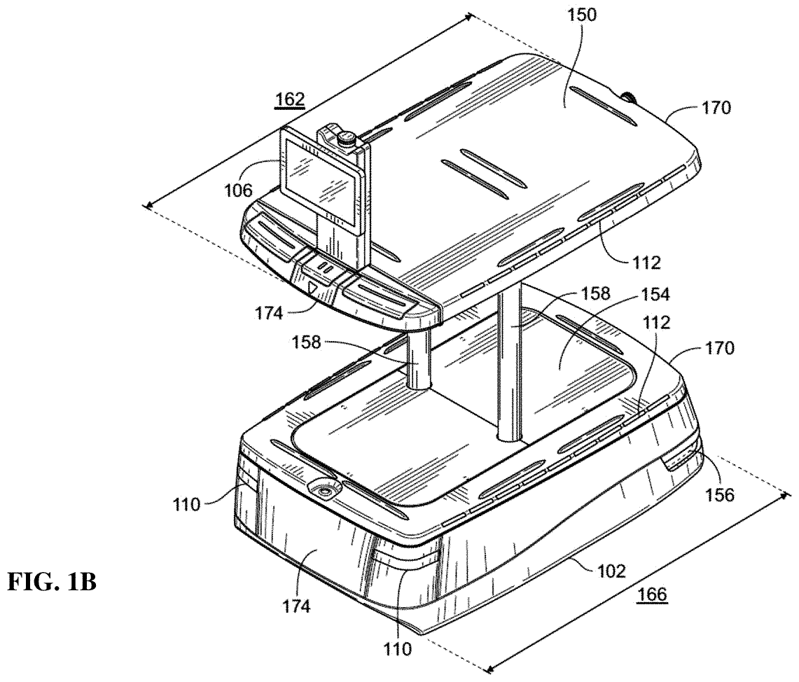

FIG. 1A depicts an enhanced cart system 100 including an enhanced cart 102 (e.g., an autonomous vehicle). As illustrated, one or more enhanced carts, often referred to in the industry as picking carts, can work alongside one or more warehouse workers 104 (also referred to as associates) to move inventory items around a warehouse. The enhanced carts 102 are intended to assist in most warehouse tasks, such as picking, re-stocking, moving, sorting, counting, or verifying items (e.g., products). These carts 102 can display information to the associate 104 through the use of a user interface (e.g., screen) 106 and/or onboard visual and/or audible indicators that improve the performance of the associates 104. The cart 102 can be propelled by a motor (e.g., an electric motor) that is coupled to a power source (e.g., a battery, a supercapacitor, etc.), such that the cart 102 moves autonomously and does not require being pushed or pulled by a human or other force. The cart 102 may travel to a charging area to charge its battery or batteries.

Referring still to FIG. 1A, the enhanced carts 102 may be configured to carry one or many similar or distinct storage containers 108, often in the form of totes or boxes, that can be used to hold one or more different products. These storage containers 108 may be removable from the enhanced cart 102. In some cases, each container 108 can be used as a separate picking location (i.e., one container 108 is a single order). In other cases, the containers 108 can be used for batch picking (i.e., each container 108 can contain multiple complete or partial orders). Each container 108 may be assigned to one or many different stations for post-pick sortation and processing. In one embodiment, one or more of the containers 108 are dedicated to batch picking of multiple types of products and another one or more containers 108 are dedicated to picking multiple quantities of a single product (e.g., for orders that only have one item). This singleton picking allows the warehouse to skip secondary sortation and deliver products directly to a packaging station. In another embodiment, one or more of the containers 108 are assigned to order picking (e.g., for potentially time sensitive orders) and one or more of the containers 108 are assigned to batch picking (e.g., for lower cost or less time sensitive orders). In yet another embodiment, one or more of the containers 108 carry product that will be used to re-stock product into storage locations. Another option is for the enhanced cart 102 to move product and/or shipments throughout the warehouse as needed between different stations, such as packing and shipping stations. In yet another implementation, one or more of the containers 108 is left empty to assist in counting product into and then back out of the container 108 as part of a cycle count task regularly carried out in warehouses for inventory management. The tasks may be completed in a mode dedicated to one task type or interleaved across different task types. For example, an associate 104 may be picking products into container “one” on the enhanced cart 102 and then be told to grab products from container “two” on the enhanced cart 102 and put them away in the same aisle.

FIG. 1B is an alternative embodiment of the enhanced cart 102, and is shown (for ease of understanding) without the storage containers 108 being present. As before, the enhanced cart 102 includes the screen 106 and lighting indicators 110, 112. In operation, the storage containers 108 may be present on the enhanced cart 102 depicted in FIG. 1B. With reference to both FIGS. 1A and 1B, the enhanced cart 102 may include first and second platforms 150, 154 for supporting a plurality of containers 108 capable of receiving products. At least one support 158 may support the first platform 150 above the second platform 154. The at least one support 158 may be substantially centrally-located along respective lengths 162, 166 of the first and second platforms 150, 154 between front and back ends 170, 174 thereof and may support the first and second platforms 150, 154 at locations disposed within interior portions of the first and second platforms 150, 154. As illustrated in FIG. 1B, the front end 170 of the cart 102 may define a cutout 156. There may be one or more sensors (e.g., light detecting and ranging (LiDAR) sensors) housed within the cutout 156. The cutout 156 permits the sensor(s) to view and detect objects in front of and to the side of (e.g., more than 180° around) the cart 102.

The following discussion focuses on the use of autonomous vehicles, such as the enhanced cart 102, in a warehouse environment, for example, in guiding workers around the floor of a warehouse and carrying inventory or customer orders for shipping. However, autonomous vehicles of any type can be used in many different settings and for various purposes, including but not limited to: driving passengers on roadways, delivering food and medicine in hospitals, carrying cargo in ports, cleaning up waste, etc. This disclosure, including but not limited to the technology, systems, and methods described herein, is equally applicable to any such type of autonomous vehicle.

### Computing Systems for Autonomous Vehicle Operation

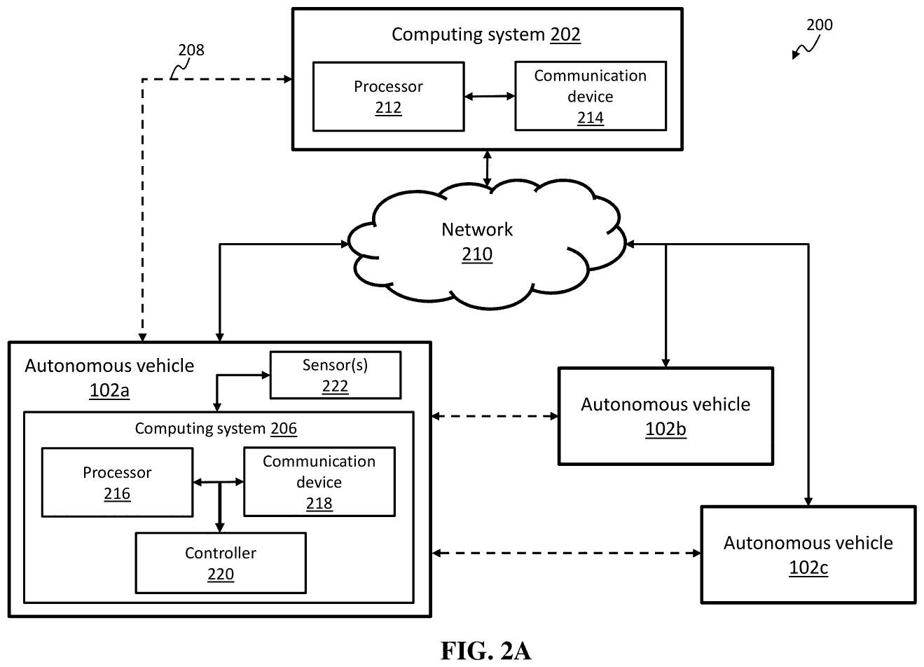

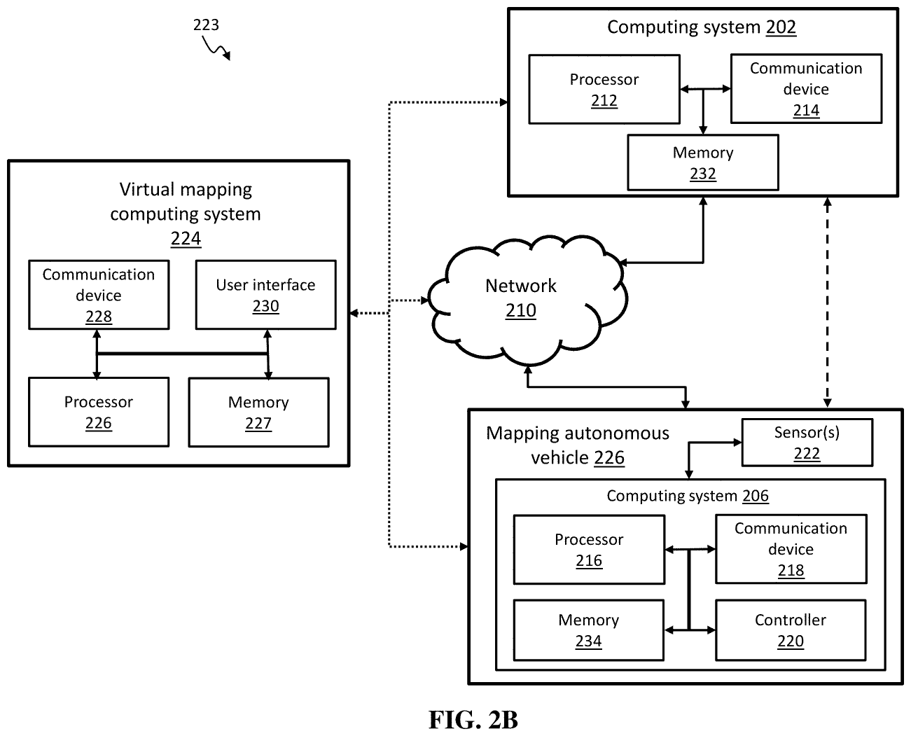

FIG. 2 illustrates a system 200 configured for sensor calibration in autonomous vehicles. The system 200 may include a remote computing system 202 configured to be coupled directly or indirectly to one or more autonomous vehicles 102a, 102b, 102c (collectively referred to as 102). For instance, the remote computing system 202 may communicate directly with the computing system 206 of an autonomous vehicle 102 (e.g., via communication channel 208). Additionally or alternatively, the remote computing system 202 can communicate with one or more autonomous vehicles 102 via a network device of network 210. In some embodiments, the remote computing system 202 may communicate with a first autonomous vehicle (e.g., vehicle 102a) via a second autonomous vehicle (e.g., vehicle 102b).

The example remote computing system 202 may include one or more processors 212 coupled to a communication device 214 configured to receive and transmit messages and/or instructions (e.g., to and from autonomous vehicle(s) 102). The example vehicle computing system 206 may include a processor 216 coupled to a communication device 218 and a controller 220. The vehicle communication device 218 may be coupled to the remote communication device 214. The vehicle processor 216 may be configured to process signals from the remote communication device 214 and/or vehicle communication device 218. The controller 220 may be configured to send control signals to a navigation system and/or other components of the vehicle 102, as described further herein.

To safely and efficiently navigate an interior space, the autonomous vehicles can include one or more sensors 222 configured to capture sensor data (e.g., e.g., images, video, audio, depth information, etc.). Such sensors 222 can include cameras, depth sensors, LiDAR sensors, inertial measurement unit (IMU), etc. The sensor(s) 222 can transmit the sensor data to the remote computing system 202 and/or to the vehicle computing system 206.

As discussed herein and unless otherwise specified, the term “computing system” may refer to the remote computing system 202 and/or the vehicle computing system 206. The computing system(s) may receive and/or obtain information about one or more tasks, e.g., from another computing system or via a network. In some cases, a task may be customer order, including the list of items, the priority of the order relative to other orders, the target shipping date, whether the order can be shipped incomplete (without all of the ordered items) and/or in multiple shipments, etc. In some cases, a task may be inventory-related, e.g., restocking, organizing, counting, moving, etc. A processor (e.g., of system 202 and/or of system 206) may process the task to determine an optimal path for one or more autonomous vehicles 102 to carry out the task (e.g., collect items in a “picklist” for the order or moving items). For example, a task may be assigned to a single vehicle or to two or more vehicles 102.

The determined path may be transmitted to the controller 220 of the vehicle 102. The controller 220 may navigate the vehicle 102 in an optimized sequence of stops (also referred to as a trip) within the warehouse to collect or move items. At a given stop, a worker near the vehicle 102 may physically place the item into a container 108 for the vehicle 102 to carry. Alternatively or additionally, the autonomous vehicle 102 may include an apparatus (e.g., a robotic arm) configured to collect items into a container 108.

Referring to FIG. 2B, example system 223 may include a virtual mapping computing system 224 configured to generate a virtual map for autonomous vehicle operation, as described in further detail below. In some instances, a map for an autonomous vehicle may be an in-memory (e.g., memory 227, memory 232, memory 234, etc.) representation of the environment (e.g., warehouse, retail space, etc.). A virtual map may refer to such a map being generated based on a virtual environment. The example system 223 may include a mapping autonomous vehicle 226 configured for mapping navigation paths, e.g., in the conversion of a conventional warehouse to an automated warehouse. Example mapping autonomous vehicle 226 may have the same or similar components and/or capabilities as autonomous vehicle 102 (e.g., vehicle 102a) including processor 216, communication device 218, controller 220, sensor(s) 222, memory 234, etc. Further, the mapping autonomous vehicle 226 may have the same or similar specifications as autonomous vehicle 102, including vehicle dimensions, sensor type(s) and placement(s) in the vehicle body, travel speeds, turn radius, etc. In some cases, there may be two or more mapping autonomous vehicles 226. The mapping vehicle 226 may communicate with the virtual mapping computing system 224 and/or (remote) computing system 202, directly and/or via network 210.

Example virtual mapping computing system 224 can include a processor 226 coupled to a communication device 228. In some embodiments, the processor 226 may be coupled to a user interface 230 configured to enable a user of the virtual mapping computing system 224 to navigate virtual models according to the processes described herein.

### Systems and Methods for Virtual Mapping

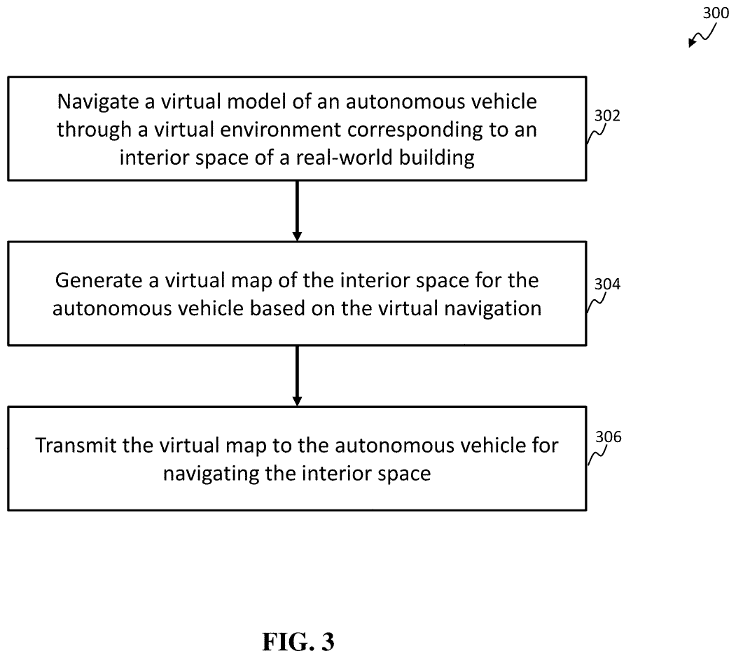

To reduce the time and resources required for initial mapping, a map of a virtual model or environment of the warehouse for autonomous vehicle operation may be generated by a computing system 224. FIG. 3 depicts a flowchart of an example method 300 for virtual mapping in autonomous vehicle operation. In step 302 of method 300, the virtual vehicle model 500 may be navigated in the virtual environment that corresponds to the interior and/or outdoor space of a real-world building (e.g., a warehouse, a retail store, etc.). As described in further detail below, step 302 may include generating and/or receiving a virtual model of the virtual environment and/or autonomous vehicle 102.

In some embodiments, a computing system 224 can be configured to obtain data representing the virtual environment of an interior space (e.g., of a warehouse, retail store, etc.). In some implementations, a modeling or simulation program (e.g., Gazebo published by the Open Source Robotics Foundation, Inc. of Mountain View, Calif., USA) operating on the computing system 224 or a computing system (e.g., a server system) coupled to system 224 can be used to simulate the virtual environment of a building, e.g., a warehouse, a retail space, etc. In some embodiments, the computing system 224 may receive one or more inputs to create the virtual representation 400 of the warehouse's interior space including one or more of warehouse blueprints, location of shelves, location of inventory in the shelves (e.g., via SKUs), and/or camera images of the interior space (e.g., the shelves, the charging area, the walls containing the interior space, etc.).

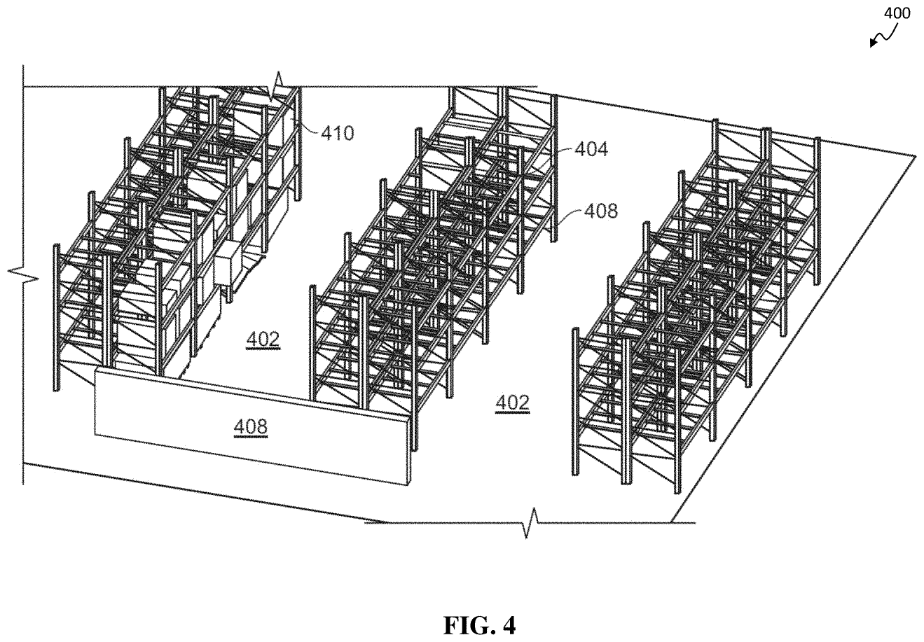

FIG. 4 illustrates a three-dimensional (3D) virtual environment 400 of an interior space of warehouse. For example, the virtual environment 400 can include representations of various features of a warehouse, including aisles 402, shelves 404, rack legs 406, walls 408, ceiling, levels, inventory 410, etc.

In various implementations, the computing system 224 can be configured to generate a virtual model of the autonomous vehicle 102. The virtual vehicle model 500 may be generated based on the received vehicle specifications. For example, one or more modeling or simulation programs (e.g., Gazebo published by the Open Source Robotics Foundation, Inc. of Mountain View, Calif., USA and Cartographer published by Google Open Source, Menlo Park, Calif., USA) can be used to simulate the autonomous vehicle 102. The vehicle model may be generated using data that describes a robot's physical description. For example, the data may be in the Unified Robot Description Format (URDF). In some cases, the computing system 224 may receive a differential drive model of the autonomous vehicle 102. The differential drive model includes data associated with the differential drive system of the physical vehicle 102. For example, the differential drive system of an autonomous vehicle 12 may include data related to its wheels, its wheel axis or axes, its instantaneous center of curvature (ICC), etc. This data can enable a computing system 224 (or a program operating on the computing system 224) to model the kinematics of the vehicle 102 relative to its environment. In some embodiments, the computing system 224 may receive data related to the specifications of an autonomous vehicle 102, including vehicle dimensions, sensor type(s) and placement(s) in the vehicle body, travel speeds, turn radius, etc. The computing system 224 can use one or more of these specifications to generate a virtual model of the autonomous vehicle 102 in the virtual environment 400. The computing system 224 may be configured such that the virtual vehicle may be navigated around a virtual environment 400 using a peripheral device (e.g., keyboard keys, computer mouse, a joystick, an electronic pen, etc.) or via a command line interface. For example, the virtual vehicle may be navigated forward (e.g., using the ↑ key), in reverse (e.g., using the ↓), to the right (e.g., using→key), and the left (e.g., using the<--key). The computing system 224 can be configured to model the velocity, acceleration, torque, etc. of the virtual vehicle. In some implementations, the specifications of the vehicle 102 may be used to determine ranges of velocity, application of force on the vehicle 102 (e.g., manually by a worker), etc. Such inputs may determine how a virtual model should navigate its virtual environment “safely” and without “harm” to the virtual model.

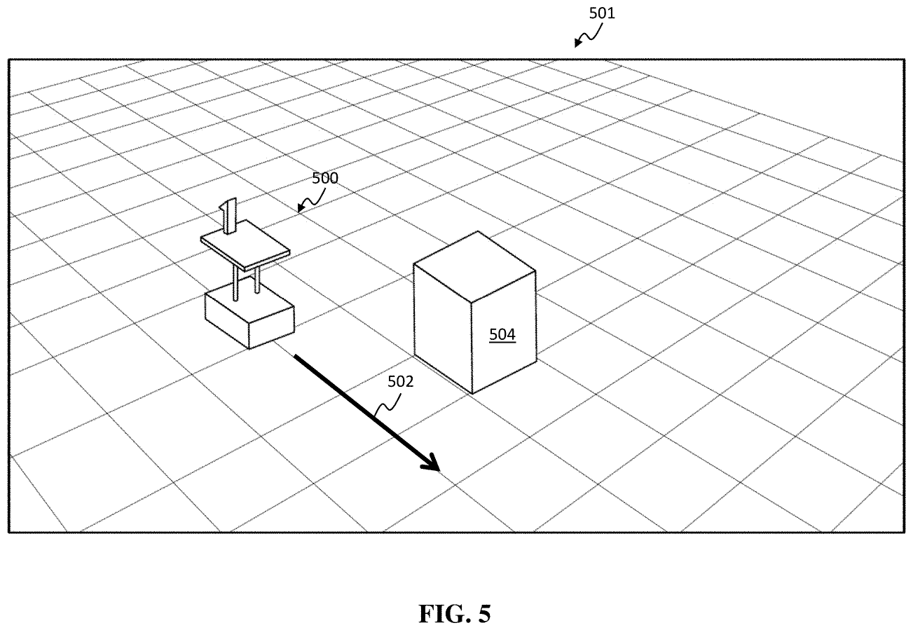

FIG. 5 illustrates a virtual model 500 of an autonomous vehicle 102 navigating within a virtual environment 501. As the vehicle model 500 navigates its environment 501, a virtual map of the environment is created. For example, the vehicle model 500 can be navigated forward along path 502. The environment 501 may include representations of objects, structures, etc. 504 that may be mapped by the computing system. In some embodiments, the virtual map may include structures 504 incident to vehicle paths 502 within the warehouse. In some embodiments, the virtual map may be more inclusive in that the virtual vehicle model 500 may be navigated in an environment more thoroughly such that likely and unlikely paths are mapped during virtual mapping. For example, the virtual vehicle 500 may be navigated to collect virtual sensor data (e.g., in a .bag file) in the Gazebo program. In parallel, a mapping pipeline may be run (e.g., via Cartographer) on the data file to form a map file (e.g., in a .pbstream file format). The .pbstream file may be used to generate one or more portable gray map (PGM) images used to visualize the virtual map. In some implementations, the virtual vehicle model 500 may be navigated through a virtual warehouse to collect a simulated picklist for a customer order.

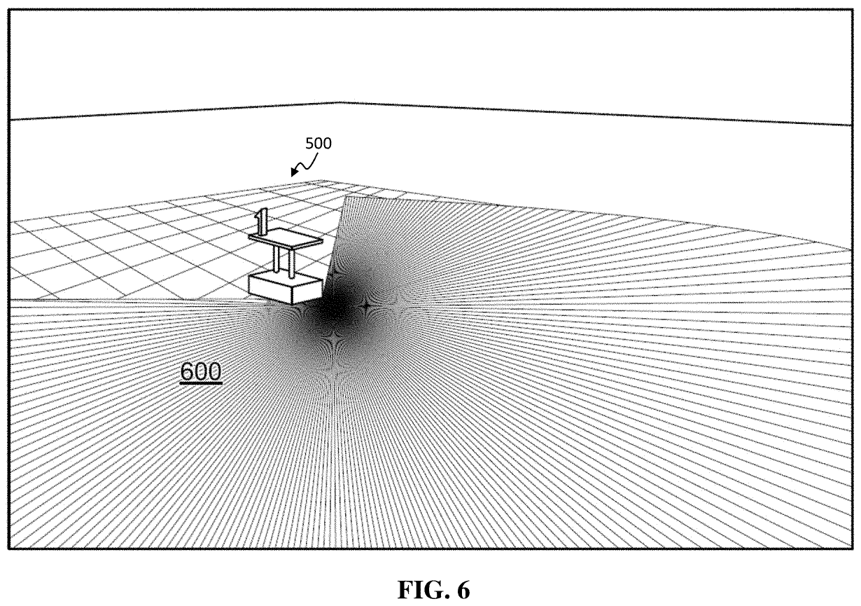

FIG. 6 illustrates the virtual model 500 of the vehicle 102 being navigated in a virtual environment 600. The model 500 can include a representation of at least one sensor's field of view 400. In some implementations, the virtual map for vehicle operation can include virtual sensor markers for navigation. The computing system 224 can be configured to generate virtual sensor markers in the virtual environment 400 such that, when a physical vehicle is placed in the physical or real-world space, the vehicle 102 can rely on the sensor markers along a given path to safely navigate. The virtual sensor markers can be a representation or a model of sensor data (also referred to as “modeled sensor data”) that a physical vehicle's sensors 222 would collect if that physical vehicle were to traverse the corresponding real-world path represented in the virtual map. Physical sensor data may include images, depth data, and/or measurements of a physical environment of the vehicle 102. Modeled sensor data may be an estimation, projection, approximation, conceptualization, and/or impression of the physical sensor data. For example, along a particular navigation path in the warehouse, the physical vehicle sensor may capture (1) a camera image of a bottom two shelves of a warehouse rack and (2) depth data or measurements indicating the distance between the physical vehicle sensor 222 and the bottom two shelves. Modeled sensor data may include (1′) a model of a camera image of the bottom two shelves in the same position as the physical sensor 222 and (2′) a model of the depth data or model of the measurements of the distance between the physical sensor 222 and the bottom two shelves. In some implementations, the virtual sensor markers may be the same as the modeled sensor data. In the example above, the virtual sensor markers may include (1′) the modeled camera image and/or (2′) the modeled depth data or measurements of the bottom two shelves of the warehouse rack. In some implementations, the virtual sensor markers may be an abstraction, pertinent features, and/or extracted data of the modeled sensor data. In some cases, the virtual sensor markers may include virtual image markers, virtual depth markers, and/or virtual measurements. In the example above, the virtual sensor makers may include one or more features of the two bottom shelves including, e.g., the height of the first bottom shelf, the height of the second bottom shelf, the legs of the warehouse rack adjacent to the shelves, the distance between the sensor and the first bottom shelf, etc.

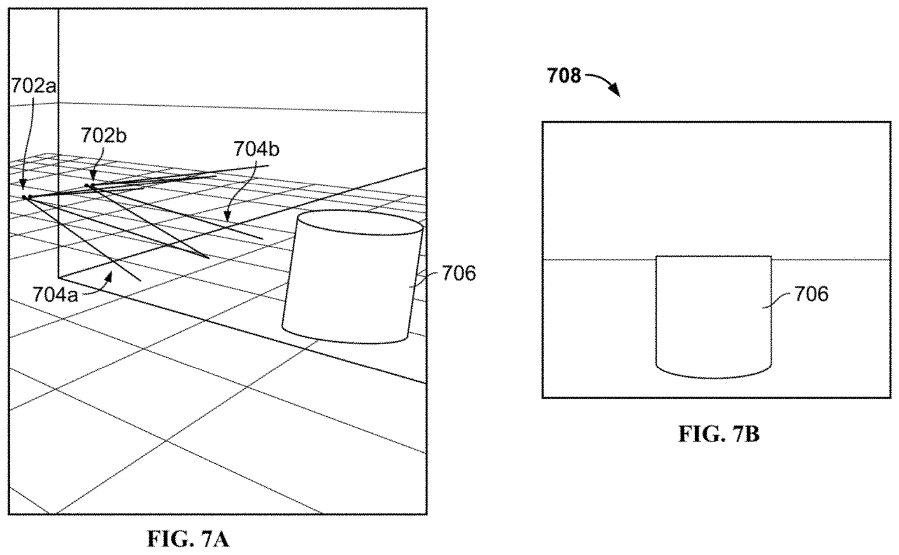

FIG. 7A illustrates a virtual model of two vehicle sensors 702a, 702b (e.g., camera and/or LiDAR) and their respective virtual fields of view 704a, 704b. The fields of view 704a, 704b are directed toward an object 706 (in the shape of a cylinder). FIG. 7B illustrates the visual sensor data 708 captured by the virtual sensors 702a, 702b. Note that the visual sensor data 708 includes the shape of the object 706 as captured by the virtual sensors 702a, 702b.

In various embodiments, physical sensors 222 of a physical vehicle 102 can be generally configured to capture sensor data that is pertinent for the movement of the vehicle 102. Therefore, in some cases, the physical sensors 222 may capture features primarily in front, rear, and/or sides of the vehicle 102. For example, a LIDAR sensor mounted on the front of the vehicle may be configured with an azimuthal scan with a field of view of 260 degrees. In some cases, the physical sensors 222 may be configured to capture a range (e.g., distance from the vehicle 102) of sensor data based on its speed of travel (e.g., average speed, maximum speed, etc.). For example, the physical depth sensor may be configured to capture depth data up to 10 feet, 20 feet, 30 feet, 50 feet, etc. in front of the vehicle 102 based on its average speed. Accordingly, virtual sensors of a virtual vehicle model 500 can be simulated to capture virtual sensor data. The virtual sensors can be simulated to capture a virtual features (e.g., of the virtual environment) that are in front, rear, and/or sides of the virtual vehicle model 500. Referring back to the example above, the virtual sensors can be similarly “configured” to capture depth data up to 10 feet, 20 feet, 30 feet, 50 feet, etc. in front of the virtual vehicle. In some implementations, the virtual sensor markers may reflect such features (as compared to less pertinent data that, in some examples, may include features of structures above or directly below the vehicle 102). As described above, the virtual sensor data may be stored as .bag files and ultimately used in generating the mapping file.

In some embodiments, physical tags may be present in a physical warehouse and may be used to orient a vehicle 102 relative to its environment and/or enable the vehicle 102 to determine its location within its internal map. For example, the tags may include a number, a barcode, etc. that can be captured by a vehicle sensor and processed by a processor (e.g., processor 216). The processed tag data can be compared to an internal map of the vehicle to pinpoint its location. Accordingly, virtual tags may be used in a similar fashion as virtual sensor markers in the virtual environment to orient the virtual vehicle 500 within its virtual environment. The virtual tags may, in some cases, be incorporated into the virtual map.

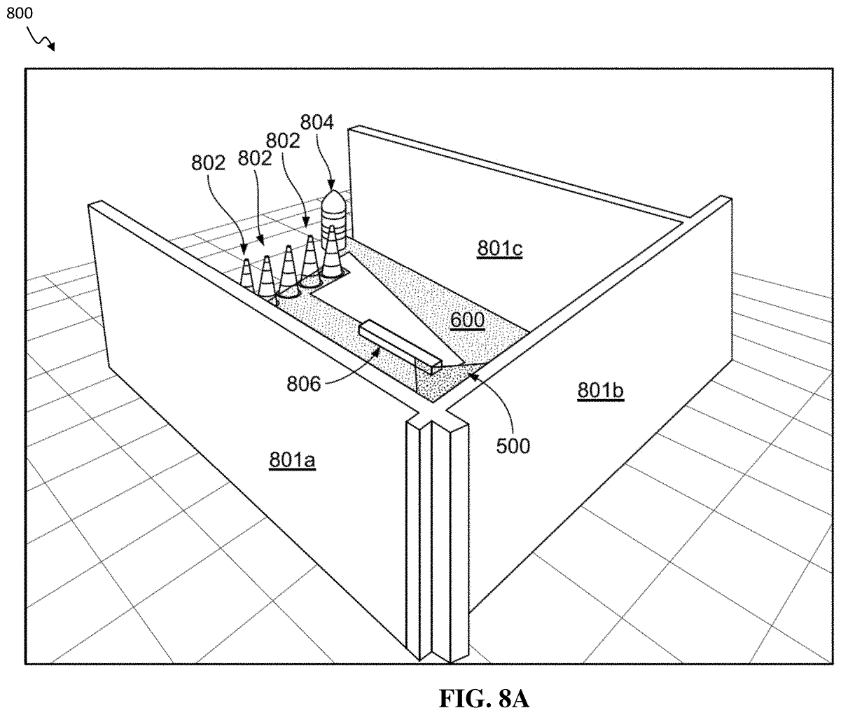

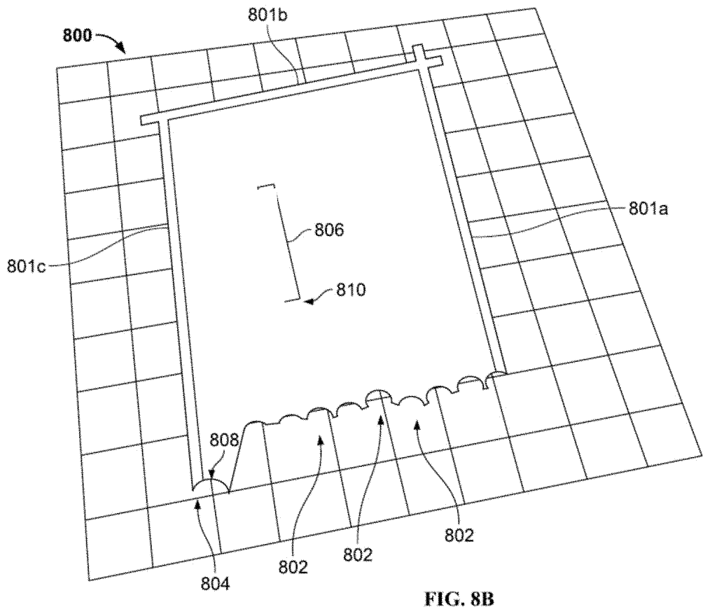

To illustrate the capturing of such features, FIG. 8A depicts the virtual model 500 of the vehicle 102 being navigated in a test virtual environment 800 (e.g., in user interface 230). The example test virtual environment 800 includes three walls 801a, 801b, 801c configured to create a semi-enclosed space in which the virtual model 500 of the vehicle 102 navigates. The semi-enclosed space includes obstacles including small cones 802, a large cone 804, and an interior bar 806. FIG. 8B illustrates the resulting sensor data from the navigation in FIG. 8A. For example, with respect to the large cone 804, the virtual sensors captured one semi-circular feature 808 of the large cone 804 that was within field of view 600. In another example, the virtual sensors captured one or more features 810 of the bar 806. These captured features can be used to form the sensor markers to be used by physical vehicles 102. For example, in a particular real-world navigation path in a warehouse, a sensor marker may be a feature of a wall (e.g., similar to the test data 810) or a feature of a pillar (e.g., similar to the test data 808).

In step 304, one or more processors (e.g., processor 226, processor 212, and/or processor 216) of one or more computing systems (e.g., system 224, system 202, and/or system 206, respectively) can be configured to generate a virtual map of the interior space for a real-world mapping autonomous vehicle 226 based on the virtual navigation of the virtual environment 400. For instance, the virtual map can include the virtual sensor markers captured during the virtual navigation, as described above. The sensor markers can include images, depth markers, and/or measurements. In some embodiments, the processor 226 can store the virtual map (e.g., including the virtual sensor markers) in a memory 227.

In some cases, the virtual map may be generated in one or more simulated lighting conditions. This may result in a set of virtual sensor markers for the same location in a warehouse but in different lighting conditions. In some implementations, a virtual sensor marker may be generated at each of high, normal, low, and/or uneven levels of lighting for a particular location in a path of the warehouse. For instance, in a real-world warehouse, a given area of the warehouse may be illuminated by windows, skylights, artificial lighting, reflected light, ambient light, lighting on vehicles 102, etc., each of which may be direct or indirect, variable with time of day or time of year, and/or based on warehouse configuration (including changes in inventory, vehicle traffic, etc.). Therefore, a given area in a warehouse may be subject to a high level of lighting, e.g., from windows during a time of direct strong sunlight and/or from a high-lumens or high-wattage spotlight. A given area of a warehouse may be subject to normal level of lighting, e.g., from windows during a typical partly sunny or partly overcast day (depending on geography) or from default lighting (e.g., average wattage or average lumens overhead lighting). A given area of a warehouse may be subject to a low level of lighting, e.g., from windows during a very overcast day or during the days of the year with fewer daylight hours or from malfunctioning or broken overhead lighting (having low wattage or low lumens). A virtual map may include a set of virtual sensor markers that includes (i) virtual sensor markers for a high level of lighting, (ii) virtual sensor markers for a normal level of lighting, and/or (iii) virtual sensor markers for a low level of lighting for a given area. In some implementations, a lighting model may be applied to the virtual environment. A lighting model may include one or more lighting levels, reflections off of materials used in the warehouse, times of day, times of year, etc. The lighting model may be considered from the perspective of the virtual sensor based on a location of the virtual vehicle in the environment. In some implementations, the virtual vehicle model 500 may be navigated over different surface types. One or more surface types (e.g., including reflective properties, textures, grain, etc.) may be present in a real-world warehouse environment and may affect the speed with which a vehicle may navigate and/or how sensor data is captured. For example, certain surfaces may be more reflective than others, causing more light to reflect back at a sensor 222. This condition may be accounted for in the virtual mapping.

In some implementations, a virtual sensor marker may be generated at various vehicle speeds for a particular navigation path. The virtual map may include a set of virtual sensor markers for a particular path or location in which a virtual sensor marker is generated at each speed of a plurality of speeds (e.g., 2 speeds, 3 speeds, 5 speeds, 10 speeds, etc.). For example, the virtual sensor marker can be generated at a low (or cautious) vehicle speed, an average speed, a top speed.

The obtained virtual sensor data can be used to set appropriate navigation settings for the mapping autonomous vehicle 226 at each location in the warehouse for its initial mapping. For example, a narrow or cluttered aisle detected may correspond to a reduced navigation speed of the autonomous vehicle in that area of the warehouse.

In step 306, the virtual map (e.g., including the virtual sensor markers) may be transmitted by a communication device 228 to a physical mapping autonomous vehicle 226 for validation in the physical (real-world) warehouse. In some cases, the map may be converted into a mapping file that can be interpreted by the autonomous vehicle 226 during navigation. The autonomous vehicle 226 may undergo an orientation (e.g., using posted markers in the interior of the warehouse) and then navigate according to the received virtual map. The autonomous vehicle 226 may navigate within the physical warehouse to confirm the virtual sensor markers. Note that a skilled engineer may not be needed to validate the virtually-created map (as compared to mapping with a skilled engineer). In some implementations, the mapping vehicle 226 may generate physical sensor markers during the physical navigation. In some cases, the physical sensor markers can be stored in a memory coupled to the processor (e.g., memory 232 coupled to processor 212 or memory 234 coupled to processor 216). These physical sensor markers may be compared by the processor to the virtual sensor markers. In some cases, the processor may capture the physical markers to replace and/or correct the virtual markers in the virtual map. The corrected virtual map may be used by any autonomous vehicle 102 in navigating the warehouse.

In some embodiments, after a space has been virtually mapped, the example systems and methods described herein can be used for a subsequent mapping (e.g., virtual mapping, including virtual sensor markers) of a space. For example, if the warehouse or retail store layout changes, then a new virtual map of the warehouse may be generated (e.g., “remapped”) or the existing virtual map of the warehouse may be altered to accommodate the changes in layout. In another example, if the space of the warehouse or retail store is expanded (e.g., via building expansion), a new virtual map of the new space may be generated and appended to the older, existing virtual map. In some embodiments, a processor 212 or 216 may integrate the new virtual map and existing virtual map. This integration may be executed once and broadcast. Alternatively, the vehicle processor 216 may integrate the new virtual map with an existing map if the particular vehicle needed to travel in the expanded space. In another example, an initial virtual map may be “tested” live by a physical vehicle in the physical warehouse found to be incorrect (e.g., incorrect dimensions, unsafe paths, etc.). This initial virtual map may be corrected or remapped with input from the live mapping by the physical vehicle.

### Computer-based Implementations

In some examples, some or all of the processing described above can be carried out on a personal computing device, on one or more centralized computing devices, or via cloud-based processing by one or more servers. In some examples, some types of processing occur on one device and other types of processing occur on another device. In some examples, some or all of the data described above can be stored on a personal computing device, in data storage hosted on one or more centralized computing devices, or via cloud-based storage. In some examples, some data are stored in one location and other data are stored in another location. In some examples, quantum computing can be used. In some examples, functional programming languages can be used. In some examples, electrical memory, such as flash-based memory, can be used.

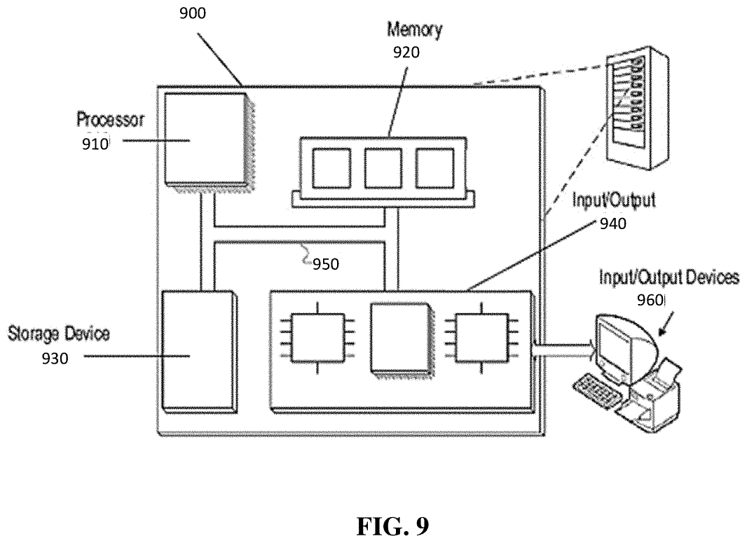

FIG. 9 is a block diagram of an example computer system 900 that may be used in implementing the systems and methods described herein. General-purpose computers, network appliances, mobile devices, or other electronic systems may also include at least portions of the system 900. The system 900 includes a processor 910, a memory 920, a storage device 930, and an input/output device 940. Each of the components 910, 920, 930, and 940 may be interconnected, for example, using a system bus 950. The processor 910 is capable of processing instructions for execution within the system 900. In some implementations, the processor 910 is a single-threaded processor. In some implementations, the processor 910 is a multi-threaded processor. The processor 910 is capable of processing instructions stored in the memory 920 or on the storage device 930.

The memory 920 stores information within the system 900. In some implementations, the memory 920 is a non-transitory computer-readable medium. In some implementations, the memory 920 is a volatile memory unit. In some implementations, the memory 920 is a non-volatile memory unit.

The storage device 930 is capable of providing mass storage for the system 900. In some implementations, the storage device 930 is a non-transitory computer-readable medium. In various different implementations, the storage device 930 may include, for example, a hard disk device, an optical disk device, a solid-date drive, a flash drive, or some other large capacity storage device. For example, the storage device may store long-term data (e.g., database data, file system data, etc.). The input/output device 940 provides input/output operations for the system 900. In some implementations, the input/output device 940 may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 960. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 930 may be implemented in a distributed way over a network, such as a server farm or a set of widely distributed servers, or may be implemented in a single computing device.

Although an example processing system has been described in FIG. 9, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

What is claimed is:

1. A computing system for virtual mapping in autonomous vehicle operation, the computing system comprising:
a processor configured to:
navigate a virtual model of an autonomous vehicle through a virtual environment corresponding to an interior space of a real-world building, and
generate a virtual map of the interior space for the autonomous vehicle based on the navigation through the virtual environment; and
a communication device coupled to the processor and configured to transmit the virtual map to the autonomous vehicle for navigating the interior space.

2. The system of claim 1, wherein the virtual map comprises a set of virtual sensor markers, the virtual sensor markers being modeled sensor data for at least one sensor of the autonomous vehicle.

3. The system of claim 2, wherein the set of virtual sensor markers comprises at least one of image markers or depth markers.

4. The system of claim 1, wherein the virtual map is generated in at least two lighting conditions, the lighting conditions comprising a first and second lighting level, the first lighting level different from the second lighting level and each of the first and second lighting levels being one of a high level of lighting, a normal level of lighting, a low level of lighting, or an uneven level of lighting.

5. The system of claim 1, wherein the processor is further configured to generate the virtual model of the autonomous vehicle based on a set of autonomous vehicle specifications.

6. The system of claim 1, further comprising a controller configured to navigate the autonomous vehicle in the interior space according to the virtual map.

7. The system of claim 6, further comprising:
a memory coupled to the processor and configured to store data from at least one sensor of the autonomous vehicle obtained during navigation of the autonomous vehicle in the interior space, and
wherein the processor is further configured to modify the virtual map according to the stored data.

8. The system of claim 1, wherein the processor is further configured to:
receive a dataset comprising:
(i) a blueprint for the interior space of the physical building, and
(ii) a plurality of images of the interior space; and
generate the virtual environment of the interior space based on the received dataset.

9. A computer-implemented virtual mapping method for autonomous vehicle operation, the method comprising:
navigating, by a computing system, a virtual model of an autonomous vehicle through a virtual environment corresponding to an interior space of a real-world building;
generating, by the computing system, a virtual map of the interior space for the autonomous vehicle based on the navigation through the virtual environment; and
transmitting, by a communication device of the computing system, the virtual map to the autonomous vehicle for navigating the interior space.

10. The method of claim 9, wherein the virtual map comprises a set of virtual sensor markers, the virtual sensor markers being modeled sensor data for at least one sensor of the autonomous vehicle.

11. The method of claim 10, wherein the set of virtual sensor markers comprises at least one of image markers or depth markers.

12. The method of claim 9, wherein the virtual map is generated in at least two lighting conditions, the lighting conditions comprising a first and second lighting level, the first lighting level different from the second lighting level and each of the first and second lighting levels being one of a high level of lighting, a normal level of lighting, a low level of lighting, or an uneven level of lighting.

13. The method of claim 9, further comprising generating, by the computing system, the virtual model of the autonomous vehicle based on a set of autonomous vehicle specifications.

14. The method of claim 9, further comprising:
navigating, by a controller of the autonomous vehicle, the autonomous vehicle in the interior space according to the virtual map.

15. The method of claim 14, wherein navigating the autonomous vehicle in the interior space according to the virtual map comprises:
autonomously navigating, by the controller, the autonomous vehicle in the interior space.

16. The method of claim 14, further comprising:
storing, by a memory coupled to the computing system, data from at least one sensor of the autonomous vehicle obtained during the navigating of the autonomous vehicle in the interior space; and
modifying, by the computing system, the virtual map according to the stored data.

17. The method of claim 16, further comprising:
transmitting, by the computing system, the modified virtual map to another autonomous vehicle.

18. The method of claim 9, wherein the virtual environment is a three-dimensional model of the interior space of the real-world building.

19. The method of claim 9, further comprising:
receiving, by the computing system, a dataset comprising:
(i) a blueprint for the interior space of the real-world building, and
(ii) a plurality of images of the interior space; and
generating, by the computing system, the virtual environment of the interior space based on the received dataset.

20. A non-transitory computer-readable medium having instructions stored thereon that, when executed by one or more computer processors, cause the computer processors to perform operations comprising:
navigating a virtual model of an autonomous vehicle through a virtual environment corresponding to an interior space of a real-world building;
generating a virtual map of the interior space for the autonomous vehicle based on the navigation through the virtual environment; and
transmitting the virtual map to the autonomous vehicle for navigating the interior space.
